(19) United States
(12) Patent Application Publication
(10) Pub. No.: US 2026/0177949 A1
(43) Pub. Date: Jun. 25, 2026

(54) ELECTROPHOTOGRAPHIC MEMBER AND ELECTROPHOTOGRAPHIC IMAGE FORMING APPARATUS

(71) Applicant: CANON KABUSHIKI KAISHA, Tokyo (JP)

(72) Inventors: SHOHEI ISHIO, Tokyo (JP); MASATSUGU TOYONORI, Kanagawa (JP); YASUTOMO TSUJI, Saitama (JP); NAOKO KASAI, Kanagawa (JP)

(21) Appl. No.: 19/425,211

(22) Filed: Dec. 18, 2025

(30) Foreign Application Priority Data
Dec. 25, 2024 (JP) 2024-229191

(51) Int. Cl. G03G 15/16

(52) U.S. Cl. CPC G03G 15/162; G03G 15/161; G03G 2215/1661

(57) ABSTRACT

An electrophotographic member having, on an outer surface thereof, a plurality of dimples, wherein regarding each shape of the plurality of dimples, in each of the dimples, when a maximum width of the dimple is denoted as WL (μm), a minimum width of the dimple is denoted as WS (μm), a maximum depth of the dimple is denoted as DM (μm), and in the plurality of dimples, when an arithmetic mean value of WS/WL is denoted as (WS/WL) Ave, an arithmetic mean value of WL is denoted as WLAve (μm), and an arithmetic mean value of DM is denoted as DMAve (μm), then (WS/WL) Ave, WLAve, and DMAve satisfy specific expressions (1) to (4), and a percentage of an area occupied by the dimples on the outer surface is 20.0 to 50.0 area %.

### BACKGROUND

### Field of the Technology

The present disclosure relates to an electrophotographic member such as a transport transfer belt, an intermediate transfer belt, or the like used in an electrophotographic image forming apparatus such as a copying machine, a printer, or the like, and to an electrophotographic image forming apparatus.

### Description of the Related Art

In an electrophotographic image forming apparatus, an electrophotographic member such as an electrophotographic belt is used as a transport transfer belt for transporting transfer material or an intermediate transfer belt for temporarily transferring and holding a toner image. There is an image forming apparatus that cleans, by using a cleaning blade made of an elastic material such as urethane rubber, untransferred toner that could not be transferred to the electrophotographic belt. In recent years, to compete with other printing methods, there has been a trend toward enhancing the durability of electrophotographic image forming apparatuses from a cost-reduction perspective, and even as durability in terms of the number of printable sheets improves, electrophotographic members with superior toner cleaning characteristics are becoming increasingly necessary.

Furthermore, if adhesion exists between the electrophotographic belt and the photosensitive drum, a friction force between the electrophotographic belt and the photosensitive drum may affect running stability of the photosensitive drum, potentially causing defects in a formed toner image. Therefore, it is necessary to reduce the friction on the surface of the electrophotographic belt to ensure superior long-term toner cleaning characteristics and maintain the running stability of the drum.

Japanese Patent Application Laid-open No. 2014-146024 discloses an electrophotographic belt having a surface layer, the surface layer containing a heteroaggregate including inorganic oxide particles having a predetermined particle size and conductive metal oxide particles having a predetermined particle size different from that of the inorganic oxide particles, a ten-point average roughness of the surface layer being within a predetermined range. Specifically, particles with opposite electrified charge polarities aggregate to form clusters and roughen the belt surface, thereby reducing friction on the belt surface. This reduces adhesion between the electrophotographic belt and the photosensitive drum and solves an issue of drum tack performance.

In addition, in examples of Japanese Patent Application Laid-open No. 2014-146024, a method of applying bias to residual toner and collecting the residual toner using a cleaning blade of the photosensitive drum is described as a belt cleaning method.

Japanese Patent Application Laid-open No. 2012-203133 discloses an intermediate transfer member having, as an outermost layer, a resin layer with dimples, formed by an inner wall of a curved surface and scattered across the surface. Specifically, this is a configuration where portions of particles exposed on the surface are removed and the missing portions of the particles form concave shapes of the surface. This configuration improves transfer performance of an intermediate transfer belt.

### SUMMARY

The present inventors carried out studies with respect to the configurations for belt cleaning using a cleaning blade and found that both the electrophotographic belt in Japanese Patent Application Laid-open No. 2014-146024 and the intermediate transfer member in Japanese Patent Application Laid-open No. 2012-203133 present problems.

The present inventors found that in the method of reducing friction of a surface by roughening the surface according to Japanese Patent Application Laid-open No. 2014-146024, there is a possibility that cleaning using the cleaning blade may be affected. For example, due to the roughening, there is a possibility that extraneous components or toner will pass through portions where the cleaning blade is no longer able to follow and cause faulty cleaning. In addition, since minute protruded portions are formed by the roughening, there is a possibility that the blade will wear down and eventually become incapable of cleaning.

If concave shapes are imparted due to the absence of particles as described in Japanese Patent Application Laid-open No. 2012-203133, there is a possibility that toner or the like of a similar size may enter the concave-shaped portions. In particular, if the size of the concave-shaped portions increases, there is a possibility that toner will become trapped in the concave-shaped portions. Toner trapped in the concave shapes in this manner cannot be scraped by the cleaning blade and may cause faulty cleaning.

As described above, in configurations using a cleaning blade, protruded portions and dimples on the belt surface may present problems. However, making the surface of an electrophotographic belt smooth presents another problem in that adhesion between a photosensitive drum and the electrophotographic belt increases, thereby increasing a friction force due to a peripheral velocity difference between the photosensitive drum and the electrophotographic belt. On the other hand, since toner acts as a lubricant between the photosensitive drum and the electrophotographic belt, the presence or absence of toner changes the friction force, which, in turn, changes a rotational speed of the photosensitive drum. When the adhesion between the photosensitive drum and the electrophotographic belt is high, a variation in the rotational speed of the photosensitive drum increases, making exposure to the drum unstable and increasing the possibility of streaky image defects (exposure blur) occurring at a leading edge of images.

The present disclosure provides an electrophotographic member to be used in an electrophotographic image forming apparatus equipped with a cleaning blade, the electrophotographic member having low adhesion to a photosensitive drum, reduced occurrence of exposure blur, and excellent toner cleanability over a long period of time. In addition, the present disclosure provides an electrophotographic image forming apparatus equipped with the electrophotographic member according to the present disclosure as an intermediate transfer belt.

One aspect of the present disclosure provides an electrophotographic member having, on an outer surface thereof, a plurality of dimples, wherein regarding each shape of the plurality of dimples, in each of the dimples, when a maximum width of the dimple is denoted as WL (μm), a minimum width of the dimple is denoted as WS (μm), a maximum depth of the dimple is denoted as DM (μm), and in the plurality of dimples, when an arithmetic mean value of WS/WL is denoted as (WS/WL) Ave, an arithmetic mean value of WL is denoted as WLAve (μm), and an arithmetic mean value of DM is denoted as DMAve (μm), then (WS/WL) Ave, WLAve, and DMAve satisfy expressions (1) to (4) below:

$$( WS / WL ) Ave \geq 0.6 \qquad ( 1 )$$

$$0.5 μm \leq WLAve \leq 4. μm \qquad ( 2 )$$

$$0. < ( DMAve / WLAve ) \leq 0.3 \qquad ( 3 )$$

$$DMAve \geq 0.1 μm , \qquad ( 4 )$$

and
a percentage of an area occupied by the dimples on the outer surface is 20.0 to 50.0 area %.

Another aspect of the present disclosure provides an electrophotographic image forming apparatus comprising the electrophotographic member of the present disclosure as an intermediate transfer belt.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view showing a configuration of an outer surface of an electrophotographic belt.

FIG. 2A and FIG. 2B are schematic views showing a cross section in a direction orthogonal to a circumferential direction of the electrophotographic belt.

FIG. 3 is a schematic view showing a method of measuring a shape of an electrophotographic member.

FIG. 4 is a schematic view showing an example of a configuration of an image forming apparatus adopting an intermediate transfer system.

FIG. 5 is a schematic view showing an example of a manufacturing method of an electrophotographic belt using a stretch blow molding machine.

FIG. 6 is a schematic view showing a configuration of an evaluation jig of adhesion between the electrophotographic belt and a photosensitive drum.

FIG. 7 is an explanatory diagram of a method of measuring a concave shape.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. Also, when numerical ranges are described in a stepwise manner, the upper and lower limits of each of the numerical ranges can be arbitrarily combined. In addition, in the present disclosure, the description such as “at least one selected from the group consisting of XX, YY and ZZ” means any of XX, YY, and ZZ, a combination of XX and YY, a combination of XX and ZZ, a combination of YY and ZZ, or a combination of XX, YY, and ZZ. In the case where XX represents a group, a plurality of members may be selected from XX, and the same is true for YY and ZZ.

The present inventors carried out studies to obtain an electrophotographic member that exhibits toner cleanability over a long period of time and also creates a sufficiently low friction force with a photosensitive drum. To this end, with respect to a shape of dimples of the electrophotographic member, studies were carried out to find a dimple shape that achieves both low friction through a reduced contact area with the photosensitive drum and sustained stable toner cleanability that allows sufficient toner removal.

Based on results thereof, the present inventors concluded that by shaping the dimples into a predetermined shape, it is possible to achieve both reduced friction between the electrophotographic member and the photosensitive drum and excellent toner cleanability of the electrophotographic member over a long period of time.

One aspect of the present disclosure provides an electrophotographic member having, on an outer surface thereof, a plurality of dimples, wherein regarding each shape of the plurality of dimples, in each of the dimples, when a maximum width of the dimple is denoted as WL (μm), a minimum width of the dimple is denoted as WS (μm), a maximum depth of the dimple is denoted as DM (μm), and in the plurality of dimples, when an arithmetic mean value of WS/WL is denoted as (WS/WL) Ave, an arithmetic mean value of WL is denoted as WLAve (μm), and an arithmetic mean value of DM is denoted as DMAve (μm), then (WS/WL) Ave, WLAve, and DMAve satisfy expressions (1) to (4) below:

$$( WS / WL ) Ave \geq 0.6 \qquad ( 1 )$$

$$0.5 μm \leq WLAve \leq 4. μm \qquad ( 2 )$$

$$0. < ( DMAve / WLAve ) \leq 0.3 \qquad ( 3 )$$

$$DMAve \geq 0.1 μm , \qquad ( 4 )$$

and
a percentage of an area occupied by the dimples on the outer surface is 20.0 to 50.0 area %.

Hereinafter, an electrophotographic belt as an electrophotographic member according to an aspect of the present disclosure will be described in detail. However, it is to be understood that the present disclosure is not limited to the following aspect.

### Electrophotographic Belt

An electrophotographic belt 5 has a plurality of dimples on an outer surface thereof. While an aspect of the electrophotographic belt 5 is not particularly limited, for example, the electrophotographic belt 5 may have a base layer and may have an elastic layer on the base layer. In addition, the electrophotographic belt 5 may have a surface layer. In other words, the outer surface of the electrophotographic belt 5 may be an outer surface of the surface layer. The surface layer may be formed on the base layer or the surface layer may be formed on the elastic layer.

As a processing method of the base layer, known processing methods of a thermoplastic resin or known processing methods of a thermosetting resin can be used. As a processing method of a thermoplastic resin, for example, a resin composition can be pelletized and molded using known molding methods such as continuous melt extrusion molding, injection molding, stretch blow molding, or inflation molding to obtain a base layer. As a processing method of the elastic layer, a similar method to the processing method of the base layer can be used.

As a processing method of the surface layer, for example, the surface layer can be obtained by molding the surface layer on the base layer or the elastic layer using a known molding method such as dip coating, spray coating, flow coating, shower coating, roll coating, spin coating, or ring coating.

Details of a method of forming dimples on the outer surface of the electrophotographic member will be described using an electrophotographic member having a surface layer as an example. Examples of the method of forming dimples include a method of using a coating solution for the surface layer that has been prepared to form dimples on the surface layer.

The dimples can be obtained by using a coating solution created by adding hydrocarbon oil to a resin-based coating material containing, for example, acrylate or methacrylate. For example, the base layer is obtained using the method described above. Then, the coating solution is applied to the base layer and the solvent is evaporated. Subsequently, the obtained coating film is wiped or the like, thereby removing hydrocarbon oil. Accordingly, the surface layer having dimples can be obtained.

The resin-based coating material may contain resins and may contain a polymerizable monomer for forming resins. When the resin-based coating material contains a polymerizable monomer, the polymerizable monomer may be polymerized on the base layer by performing UV irradiation or the like at least before or after evaporation of the solvent. Hereinafter, at least one selected from the group consisting of resins and polymerizable monomers for forming resins will be referred to as a resin component.

Although a detailed mechanism is not fully understood, it is presumed that a hydrocarbon oil dissolved in the solvent within the coating solution forms oil droplets on the coating film surface as the solvent evaporates, and removing the hydrocarbon oil after the coating film hardens results in the formation of dimples.

Since a size of the dimples (diameter denoted by WL and WS and depth denoted by DM to be described later) and a percentage of an area occupied by the dimples vary depending on a type and a content of the hydrocarbon oil, the hydrocarbon oil content may be adjusted according to the desired size and the desired percentage of area. While a content of the hydrocarbon oil in the coating solution is not particularly limited, the content relative to 100 parts by mass of the resin component preferably is from 3.0 to 18.0 parts by mass, more preferably is from 4.0 to 15.0 parts by mass, even more preferably is from 4.0 to 11.0 parts by mass, and particularly preferably is from 4.0 to 6.0 parts by mass. As the hydrocarbon oil content increases, the dimples tend to become larger; as the hydrocarbon oil content decreases, the dimples tend to become smaller. The shape of the dimples becomes more suitable within the range described above.

Since hydrocarbon oils should preferably be a liquid under coating conditions or, in other words, at room temperature (23 to 30° C.), hydrocarbon oils with a melting point at or below room temperature (for example, 30° C. or lower, or 23° C. or lower) are desirably used.

Examples of hydrocarbon oils include olefinic compounds and paraffinic compounds. Specifically, as olefinic hydrocarbons, straight-chain unsaturated hydrocarbons such as hexene, octene, decene, dodecene, and tetradecene, branched-chain unsaturated hydrocarbons such as diisobutylene and triisobutylene, and cyclic unsaturated hydrocarbons such as cyclohexene and dicyclopentene can be used.

As paraffinic oils, straight-chain saturated hydrocarbons such as hexane, heptane, octane, nonane, decane, undecane, dodecane, tridecane, tetradecane, pentadecane, hexadecane, heptadecane, and octadecane, branched-chain saturated hydrocarbons such as isohexane, isoheptane, isooctane, isododecane, isotridecane, isotetradecane, isopentadecane,isohexadecane, isoheptadecane, isooctadecane, isoeicosane, and cyclic saturated hydrocarbons such as cyclohexane can be used.

Alternatively, a mixture of a plurality of types of hydrocarbon oils with different carbon numbers may be used. As the hydrocarbon oil, hydrocarbon compounds commonly sold as liquid paraffin can also be used.

For example, the carbon number of the hydrocarbon oil may be from 8 to 35, preferably be from 8 to 18, more preferably be from 10 to 18, even more preferably be from 14 to 18, and even more preferably be from 15 to 18. Alternatively, the carbon number of the hydrocarbon oil may be from 25 to 35.

In addition, by adding an emulsifier along with the hydrocarbon oil, it is possible to control the diameter indicated by WL, WS, and the like, the depth indicated by DM, and the percentage of area occupied by the dimples to be described later. In other words, the coating solution preferably contains an emulsifier.

The shape of the dimples formed in the coating film surface varies depending on a combination between the emulsifier and the hydrocarbon oil and an amount of the emulsifier. For example, increasing the amount of emulsifier tends to reduce WL, WS, and DM, and tends to increase the percentage of area occupied by the dimples. In addition, reducing the amount of emulsifier tends to increase WL, WS, and DM, and tends to reduce the percentage of area occupied by the dimples.

Furthermore, even when hydrocarbon oil alone cannot form dimples, adding an emulsifier makes it easier to form dimples.

A hydrophilic-lipophilic balance (HLB) value of the emulsifier preferably is from 4 to 9. Emulsifiers with an HLB value of less than 4 exhibit high lipophilicity. Therefore, adding an emulsifier increases the compatibility between hydrocarbon oil and resin-based coating materials. As a result, oil droplet shapes cannot form on the surface and, conceivably, dimples are less likely to form after the coating film hardens. As a result, it becomes difficult to suppress the occurrence of exposure blur. On the other hand, emulsifiers with an HLB value of higher than 9 exhibit high hydrophilicity. Therefore, compatibility with resin-based coating materials is low and, conceivably, it will be difficult to achieve a surface-active effect with hydrocarbon oil. As a result, an effect of deforming concave shapes that is expected as an emulsifier will be limited and is therefore not desirable as the emulsifier to be added.

Specific examples of such emulsifiers include stearate esters such as polyglyceryl-4 stearate, polyglyceryl-4 tristearate, polyglyceryl-6 tristearate, polyglyceryl-6 pentastearate, polyglyceryl-2 isostearate, polyglyceryl-4 isostearate, and polygyceryl-10 pentaisostearate, and oleate esters such as polygyceryl-2 oleate, polygyceryl-4 oleate, and polygyceryl-6 pentaoleate.

While a content of the emulsifier in the coating solution is not particularly limited, the content relative to 100 parts by mass of the hydrocarbon oil preferably is from 5.0 to 50.0 parts by mass, more preferably is from 5.0 to 30.0 parts by mass, and particularly preferably is from 10.0 to 30.0 parts by mass. The shape of the dimples becomes more suitable within the range described above.

Known materials such as antioxidants, ultraviolet absorbers, and leveling agents may preferably be used as the coating solution.

In particular, the coating solution preferably contains a leveling agent. Accordingly, portions other than the dimples of the coating film obtained from the coating solution can be more readily made flatter. While a content of the leveling agent in the coating solution is not particularly limited, when the coating solution contains resin, the content relative to 100 parts by mass of the resin may be from 0.1 to 0.5 parts by mass.

In addition, while a method of using a coating solution has been described as a method of forming dimples on the outer surface of the electrophotographic member, as another method, concave shapes may be imparted to the surface by, for example, imprinting.

The thickness of the electrophotographic belt 5 is preferably from 10 μm to 500 μm and particularly preferably from 30 μm to 150 μm.

In addition to being used as an electrophotographic belt, the electrophotographic member may be used wrapped around or coated onto a drum or a roll. In addition, the electrophotographic member may be used as an intermediate transfer member. In other words, for example, the electrophotographic member may be an intermediate transfer belt. While a shape of the electrophotographic member is not particularly limited, an endless belt shape is preferable.

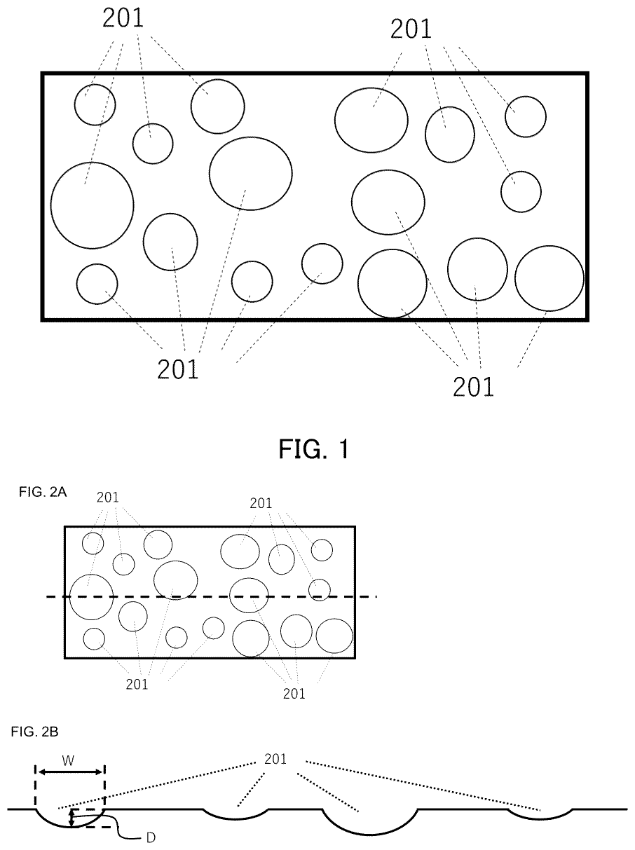

FIG. 1 is a schematic view showing a configuration of an outer surface of an electrophotographic belt.

A plurality of dimples 201 are imparted to the outer surface of the electrophotographic belt 5. Accordingly, a contact area between the photosensitive drum and the electrophotographic belt 5 can be reduced and a friction force can be reduced. As a result, adhesion with the photosensitive drum is reduced. In other words, drum tackiness improves. In FIG. 1, the dimples 201 are arranged irregularly.

FIG. 2B shows a sectional view in a direction orthogonal to a circumferential direction of the electrophotographic belt 5. FIG. 2B is a sectional view of a dotted line portion in FIG. 2A. In FIG. 2B, W denotes a width of a dimple and D denotes a depth of the dimple.

The dimple 201 will be described. The dimple 201 is provided in plurality on the electrophotographic belt 5. The dimples 201 are irregularly arranged on the outer surface of the electrophotographic belt 5.

The shapes of the dimples 201 are defined using the following parameters. Regarding the shapes of the plurality of dimples 201 observed from a side of the outer surface of the electrophotographic member at a magnification of 150× using a laser microscope, in each dimple, a maximum width of the dimple will be denoted as WL (μm) and a minimum width of the dimple will be denoted as WS (μm). In addition, a maximum depth of the dimple will be denoted as DM (μm).

Regarding WL, WS, and DM, the electrophotographic belt 5 is observed from the side of the outer surface with a 150× magnification objective lens using a laser microscope (VK-X200, manufactured by KEYENCE CORPORATION). WL, WS, and DM of each dimple observed within a field of view of the outer surface of the observed electrophotographic belt 5 are measured.

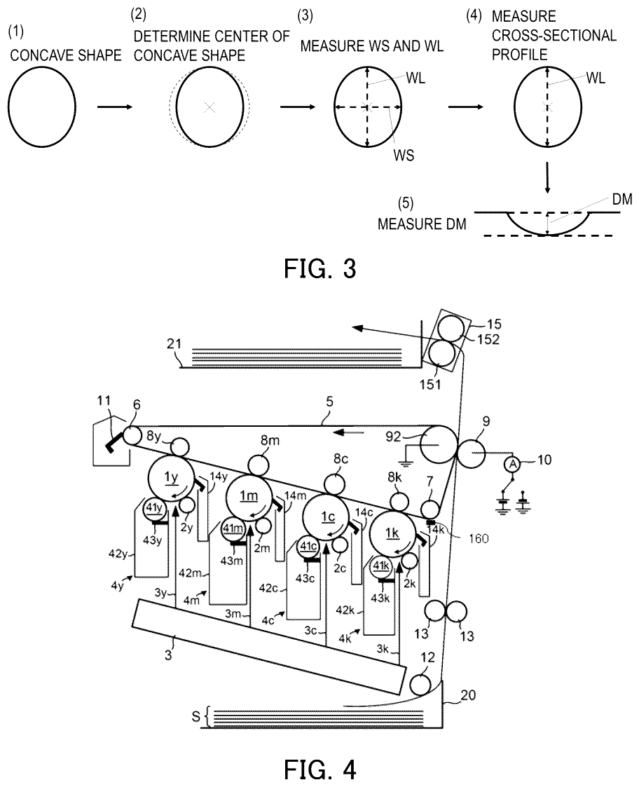

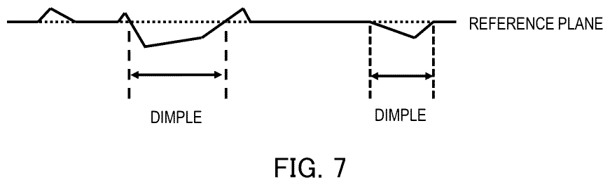

A specific measurement method will be described with reference to FIGS. 3 and 7. While an example of the measurement method according to the present embodiment will be described below, note that methods of measuring each dimple are not limited thereto.

First, a reference plane of the electrophotographic belt is defined in a cross-sectional profile obtained by the laser microscope. Since the surface of the electrophotographic belt typically has a flat portion, the flat portion is set as a reference plane. There is a location on the cross-sectional profile where a dimple is formed relative to the reference plane. This portion is defined as a dimple. Specifically, as shown in FIG. 7, a portion having a depth of 0.01 μm or more relative to the reference plane is defined as a dimple, and a region of the dimple is defined as the entire portion below the reference plane.

With respect to a shape (hereinafter, also referred to as a concave shape) of an edge of a dimple confirmed in the field of view, first, a center is determined. A center of a smallest circumscribing circle among circumscribing circles that circumscribe the concave shape is defined as a center of the concave shape ((2) in FIG. 3). Among widths that pass through the center, a longest width reaching an end of the concave shape is defined as WL and a shortest width is defined as WS ((3) in FIG. 3). In addition, a cross-sectional profile that passes through the center of the concave shape and oriented along WL is measured ((4) in FIG. 3). Then, a depth between a deepest point in the cross-sectional profile and a flat portion is defined as DM ((5) in FIG. 3). In this case, the flat portion refers to a portion of the outer surface of the electrophotographic member other than the portions with dimples.

This enables WL, WS, and DM of the observed dimples to be measured. WL, WS, and DM are measured for all dimples within the field of view, and the number of dimples and WL, WS, and DM for each dimple are recorded. In addition, (WS/WL) is also recorded at this time as an aspect ratio of each dimple.

Measurements of the shapes are taken at a total of 18 points: three points in the width direction and six points in the circumferential direction of the electrophotographic belt. Measurements in the width direction are to be performed at positions of 0 mm and ±100 mm, with a center in the width direction of the electrophotographic belt as the reference. The signs indicate a measurement position relative to the reference position. In other words, the position at −100 mm is point-symmetrical to the position at +100 mm, with the 0 mm position as the reference. In the present disclosure, the signs indicate a coating direction of the coating solution, with an upstream side in the coating direction being positive and a downstream side in the coating direction being negative. Specifically, “+100 mm” refers to a point 100 mm upstream in the coating direction of the coating solution from the center in the width direction of the electrophotographic belt. In addition, the circumferential direction is evaluated at intervals of one-sixth of the circumferential length.

A measurement of each dimple is taken at each of the measurement points described above, an arithmetic mean value of all results is calculated, and WLAve, (WS/WL) Ave, and DMAve are calculated, respectively. In other words, in the plurality of dimples, the arithmetic mean value of WS/WL will be denoted as (WS/WL) Ave, the arithmetic mean value of WL will be denoted as WLAve (μm), and the arithmetic mean value of DM will be denoted as DMAve (μm). With respect to WLAve, (WS/WL) Ave, and DMAve, the following relationships are preferable.

Regarding the size of the dimple, when too small, it becomes difficult to reduce the friction force and effectiveness as a dimple cannot be displayed, but when too large, the risk of toner slipping through increases. Therefore, WLAve satisfies expression (2) below. In addition, WLAve preferably satisfies expression (2-1) below.

$$0.5 μm \leq WLAve \leq 4. μm \qquad ( 2 )$$

$$1.5 μm \leq WLAve \leq 3.5 μm \qquad ( 2 - 1 )$$

In addition, when the dimple is deep relative to its size and the dimple is steep, toner may penetrate into the dimple and may potentially slip through beyond the reach of the cleaning blade. Such cases may possibly lead to faulty cleaning. On the other hand, when the dimple is too shallow, the effectiveness of the dimple will be lost.

Therefore, WLAve and DMAve satisfy expressions (3) and (4) below.

$$0. < ( D MAve / WLAve ) \leq 0.3 \qquad ( 3 )$$

$$DMAve \geq 0.1 μm \qquad ( 4 )$$

WLAve and DMAve preferably satisfy expression (3-1) below, more preferably satisfy expression (3-2) below, and even more preferably satisfy expression (3-3) below.

$$0. < ( D MAve / WLAve ) \leq 0.24 \qquad ( 3 - 1 )$$

$$0.1 \leq DMAve / WLAve ) \leq 0.24 \qquad ( 3 - 2 )$$

$$0.17 \leq DMAve / WLAve ) \leq 0.24 \qquad ( 3 - 3 )$$

In addition, when the dimple is wide, the dimple is preferably deep. From this perspective, WLAve and DMAve also preferably satisfy expression (3-4) below.

$$0.10 \leq ( D M Ave / WLAve ) \leq 0.3 \qquad ( 3 - 4 )$$

The value of DMAve/WLAve can be changed by changing the depth and the width of the dimple by, for example, increasing or reducing the amount of hydrocarbon oil. In addition, the value of DMAve/WLAve can also be changed depending on the type of hydrocarbon oil. Furthermore, when an emulsifier is used, the depth and the width of the dimple can be similarly changed by increasing or reducing the amount of emulsifier used or depending on the type of emulsifier.

DMAve preferably satisfies expression (4-1) below and more preferably satisfies expression (4-2) below.

$$1.2 μm \geq DMAve \geq 0.1 μm \qquad ( 4 - 1 )$$

$$0.7 μm \geq DMAve \geq 0.1 μm \qquad ( 4 - 2 )$$

In addition, the electrophotographic belt according to the present disclosure is capable of performing pressure release solely with the dimples even while maintaining a steady state of the cleaning blade, thereby reducing blade wear and extending its service life. In this case, if the dimple extends diagonally relative to the rotation direction of the electrophotographic belt, a region of the pressure-release portion of the blade undergoes relative lateral movement with respect to the blade as it passes through the dimple. Therefore, the release region extends over a wide region and causes cleanability to become unstable. Therefore, by reducing the number of dimples that can be positioned at an angle relative to the rotation direction of the electrophotographic belt and minimizing the amount of relative lateral movement, cleanability becomes more stable. In other words, the concave shape is preferably close to a circular shape. Therefore, (WS/WL) Ave satisfies expression (1) below. In addition, (WS/WL) Ave preferably satisfies expression (1-1) below, more preferably satisfy expression (1-2) below, and even more preferably satisfies expression (1-3) below.

$$( WS / WL ) Ave \geq 0.6 \qquad ( 1 )$$

$$1. \geq ( WS / WL ) Ave \geq 0.6 \qquad ( 1 - 1 )$$

$$1. \geq ( WS / WL ) Ave \geq 0.8 \qquad ( 1 - 2 )$$

$$1. \geq ( WS / WL ) Ave \geq 0.9 \qquad ( 1 - 3 )$$

The percentage of area (area %) occupied by dimples on the outer surface of the electrophotographic member will also be explained. The percentage of area is an arithmetic mean value of the percentage (area %) of the measured area occupied by dimples at each measurement point.

The percentage of area occupied by dimples at each measurement point is calculated using a total area of dimples within the field of view and an area of the entire field of view. Since the entire field of view has a rectangular shape, the area of the entire field of view is an area of a rectangle. When the concave shape is circular or elliptical, the area of each dimple can be calculated as WS×WL×π/4. In addition, a sum of the areas of the dimples in the field of view is adopted as the total area of the dimples in the field of view. In order to produce the effect of the dimples, the calculated area ratio of the dimples must be sufficient to distribute the dimples relatively uniformly across the outer surface of the electrophotographic member. On the other hand, too many dimples cause excessive pressure release, resulting in cleanability becoming unstable. Therefore, the percentage of the area occupied by the dimples on the outer surface is from 20.0 to 50.0 area %. In addition, the percentage of the area preferably is from 26.0 to 45.0 area %.

### Electrophotographic Image Forming Apparatus

FIG. 4 shows an example of an image forming apparatus which is mounted with an electrophotographic member based on the present disclosure as an intermediate transfer belt and which is configured as an electrophotographic apparatus.

In other words, the electrophotographic image forming apparatus according to the present disclosure comprises the electrophotographic member according to the present disclosure as an intermediate transfer belt.

The image forming apparatus forms color images using toners of four colors represented by C (cyan), M (magenta), Y (yellow), and K (black) with respect to a recording medium S such as paper supplied from a paper feeding cassette 20. The image forming apparatus has an image forming station for each color arranged approximately horizontally. The image forming stations are provided with photosensitive drums 1c, 1m, 1y, and 1k, respectively. Here, adding the subscripts “c,” “m,” “y,” or “k” to a reference sign indicates which color image forming station a component bearing the reference sign belongs to.

The image forming apparatus is provided with a laser scanner 3 that is a laser optical unit, and from the laser scanner 3, laser beams 3c, 3m, 3y, and 3k corresponding to image signals of each color are emitted toward the respective photosensitive drums 1c, 1m, 1y, and 1k (image exposure). Since all image forming stations share the same structure, here, the image forming station for the color K will be described.

A conductive roller 2k that is a contact charging apparatus, a developing device 4k, a conductive roller that is a primary transfer roller 8k, and a toner recovery blade 14k used to clean the photosensitive drum 1k are arranged so as to surround the photosensitive drum 1k. The developing device 4k is provided with a developing roller 41k that is a developing material bearing member for developing a latent image on the photosensitive drum 1k, a developer container 42k that holds toner to be supplied to the developing roller 41k, and a developing blade 43k that restricts a toner amount on the developing roller 41k and imparts a charge.

The electrophotographic belt 5 is configured as an endless belt and commonly provided for each color image forming station, stretched over a secondary transfer opposing roller 92, a tension roller 6, and a driver roller 7, and rotates in a direction indicated by an arrow due to the driver roller 7. In a section between the tension roller 6 and the driver roller 7, the electrophotographic belt 5 sequentially comes into contact with surfaces of the photosensitive drums 1c, 1m, 1y, and 1k and is pressed toward the photosensitive drums 1c, 1m, 1y, and 1k by primary transfer rollers 8c, 8m, 8y, and 8k. Accordingly, the toner images formed on the surfaces of the photosensitive drums 1c, 1m, 1y, and 1k are to be transferred to the surface of the electrophotographic belt 5 that is the intermediate transfer member.

The transfer of the toner image from the photosensitive drum to the intermediate transfer member will be referred to as a primary transfer and a location where the primary transfer occurs from the photosensitive drum 1 to the electrophotographic belt 5 will be referred to as a primary transfer portion.

In addition, in order to improve transferability of the primary transfer, a velocity difference (peripheral velocity difference) is provided between a peripheral velocity of the photosensitive drum 1 and a peripheral velocity of the electrophotographic belt 5. In the present embodiment, the peripheral velocity difference is provided by setting the peripheral velocity of the photosensitive drum 1 lower than the peripheral velocity of the electrophotographic belt 5. However, according to studies carried out by the present inventors, it was found that the effect of improving primary translatability does not change significantly even in a reverse case. In other words, the peripheral velocity difference may be provided by setting the peripheral velocity of the electrophotographic belt 5 lower than the peripheral velocity of the photosensitive drum 1.

To achieve favorable primary transfer of the toner image, an absolute value of the peripheral velocity difference (|{(peripheral velocity of electrophotographic belt-peripheral velocity of photosensitive drum)/peripheral velocity of electrophotographic belt}|)×100[%]) is, for example, 10% or less, preferably 5% or less, and more preferably 3% or less. In the present example, the peripheral velocity difference is set to 1.5%, and while the peripheral velocity of the electrophotographic belt 5 is set to 210 mm/sec, the peripheral velocity of the photosensitive drum 1 is set to a smaller value of 206.85 mm/sec.

A secondary transfer roller 9 is provided so as to oppose the opposing roller 92, and the electrophotographic belt 5 is pressed toward the opposing roller 92 by the secondary transfer roller 9. A secondary transfer voltage is applied to the secondary transfer roller 9 from a power supply via a current detecting circuit 10. The secondary transfer roller 9 and the opposing roller 92 constitute a secondary transfer portion.

By passing through a nip portion constituted of the electrophotographic belt 5 and the secondary transfer roller 9 at the position of the opposing roller 92 via a feeding roller 12 and a transport roller 13, the toner image held on the outer circumferential surface of the electrophotographic belt 5 is to be transferred to the recording medium S. Accordingly, an image is formed on a surface of the recording medium S.

As the recording medium S to which the toner image has been transferred passes through a fixing unit 15 made up of a roller pair constituting a heating roller 151 and a pressure roller 152, the image is fixed and the recording medium S is discharged to a paper discharge tray 21.

A cleaning blade 11 that comes into contact with the outer circumferential surface of the electrophotographic belt 5 is provided at the position of the tension roller 6. Toner remaining on the outer circumferential surface of the electrophotographic belt 5 without being transferred to the recording medium S is scraped off and removed by the cleaning blade 11. The cleaning blade 11 is a member extending in a direction that is approximately orthogonal to the movement direction of the electrophotographic belt 5. The electrophotographic image forming apparatus is preferably equipped with a cleaning member of the electrophotographic member. In addition, the electrophotographic image forming apparatus is preferably equipped with a blade member as the cleaning member. An example of the blade member is the cleaning blade 11.

While a material of the cleaning blade 11 is not particularly limited as long as the material is suitable for toner cleaning, examples of the material include urethane rubber, acrylic rubber, nitrile rubber, and EPDM rubber, and from the perspective of toner cleaning, urethane rubber is preferable.

A tinge of printed materials may vary depending on conditions such as a use environment of the image forming apparatus. Therefore, it is necessary to measure density as appropriate and provide feedback to a control mechanism within a main body. A toner image for density correction is transferred to the surface of the electrophotographic belt 5 and then transported to the position of the driver roller 7 as the electrophotographic belt 5 rotates. The toner density is detected by a density detection sensor 160 positioned on the opposite side to the driver roller 7 with respect to the electrophotographic belt 5.

While operations of the image forming apparatus are as described above, problems arising from the state of the surface of the electrophotographic belt will now be described.

First, an image defect due to exposure which occurs when the adhesion between the photosensitive drum 1 and the electrophotographic belt 5 is high will be described. As described earlier, when there is a velocity difference (peripheral velocity difference) between the peripheral velocity of the photosensitive drum 1 and the peripheral velocity of the electrophotographic belt 5, a friction force due to a difference in friction coefficients between the photosensitive drum 1 and the electrophotographic belt 5 is created. In addition, the friction force changes depending on whether or not toner which acts as a lubricant is present between the photosensitive drum 1 and the electrophotographic belt 5, which in turn changes the rotational speed of the photosensitive drum 1.

Accordingly, image exposure to the photosensitive drum 1 may become blurred and streaky image defects (exposure blur) may occur at a leading edge of the image. The exposure blur tends to occur when there is a sudden change from a state without toner to a state with toner between the photosensitive drum 1 and the electrophotographic belt 5. In other words, exposure blur is likely to occur when the region on the electrophotographic belt 5 entering the primary transfer portion changes from a non-image portion to an image portion. Typically, exposure blur tends to occur when the region on the electrophotographic belt 5 entering the primary transfer portion changes from a non-image region on a downstream side (toward a leading edge) with respect to the direction of movement of the surface of the electrophotographic belt 5 of an image region set for each sheet of the recording medium S to the image region.

Second, faulty cleaning in which the cleaning blade can no longer clean residual toner will be described. Several reasons for the occurrence of faulty cleaning are conceivable.

One reason is that the cleaning blade may become worn or otherwise altered, resulting in insufficient scraping performance. For example, the cleaning blade could conceivably wear down due to coming into contact with protruded portions on the surface of the electrophotographic belt. From this perspective, the outer surface of the electrophotographic member preferably has no protruded portions. In other words, portions of the outer surface of the electrophotographic member other than the dimples are preferably flat.

Another reason is that the cleaning blade lacks sufficient trackability, resulting in inadequate toner cleanability and allowing toner to pass through. For example, when toner enters the dimples on the outer surface of the electrophotographic belt, the toner may remain in the dimples to be carried through because the cleaning blade cannot reach the toner or the cleaning blade cannot scrape the toner off. In any case, there is a possibility that toner cannot be cleaned when there are dimples or protruded portions on the outer surface of the electrophotographic belt.

As described above, according to studies carried out by the present inventors, the condition of the surface of the electrophotographic belt may lead to image defects in the image forming apparatus. Therefore, it is necessary to determine whether or not the electrophotographic belt can be used as an intermediate transfer belt. To this end, in the following examples, the electrophotographic belt is used as an intermediate transfer belt for evaluation.

### EXAMPLES

While the present disclosure will be described in specific terms by presenting examples and comparative examples below, it should be noted that the present disclosure is not limited thereto.

### Example 1

### Production of Base Layer

First, a thermoplastic resin composition was prepared by hot-melt kneading the following base layer materials in a ratio of PEN/PEEA/CB=84/15/1 (mass ratio) using a twin-screw extruder (model: TEX30α, manufactured by The Japan Steel Works, Ltd.). A hot-melt kneading temperature was adjusted to fall within a range from 260° C. to 280° C. and a hot-melt kneading time was set at 3 to 5 minutes. The obtained thermoplastic resin composition was pelletized and dried at 140° C. for 6 hours.

### Base Layer Material

PEN: polyethylene naphthalate (trade name: TN-8050SC, manufactured by Teijin Chemicals Ltd.)
PEEA: polyether ester amide (trade name: PELESTAT NC6321, manufactured by Sanyo Chemical Industries, Ltd.)
CB: carbon black (trade name: MA-100, manufactured by Mitsubishi Chemical Corporation)

Next, the dried pellet-shaped thermoplastic resin composition was fed into an injection molding apparatus (model: SE180D, manufactured by Sumitomo Heavy Industries, Ltd.). Then, with a cylinder set temperature at 295° C., injection molding was performed into a mold maintained at 30° C. to fabricate a preform. The obtained preform had a test tube shape with an outer diameter of 50 mm, an inner diameter of 46 mm, and a length of 100 mm.

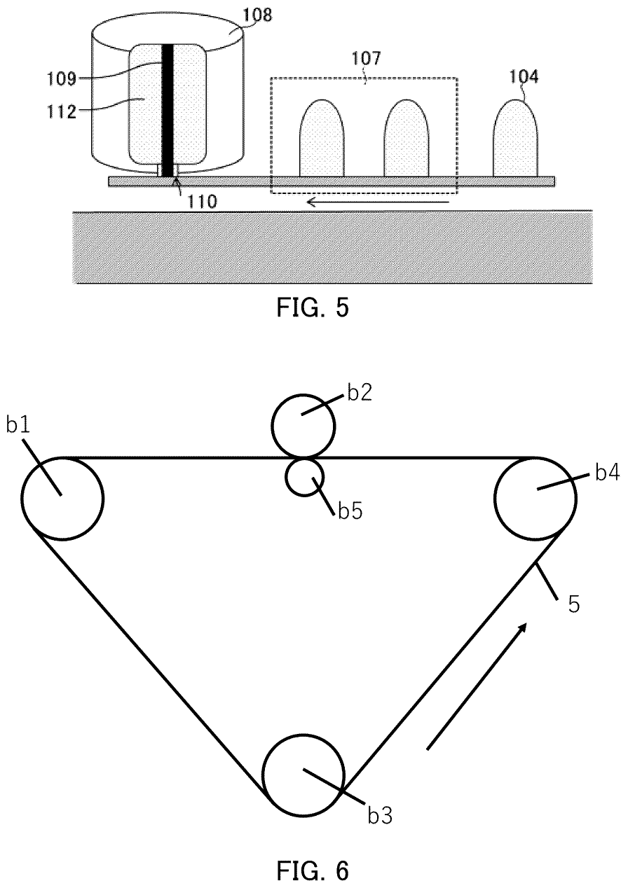

Next, the preform described above was biaxially stretched using a biaxial stretching apparatus (stretch blow molding machine) shown in FIG. 5. Prior to the biaxial stretching, a preform 104 was arranged inside a heating apparatus 107 equipped with a non-contact heater (not illustrated) for heating outer and inner walls of the preform 104, and the preform was heated by the heater until its outer surface temperature reached 150° C.

Next, the heated preform 104 was arranged inside a blow mold 108 that was maintained at a mold temperature of 30° C., and stretched axially using a stretching rod 109. At the same time, air conditioned to 23° C. was introduced into the preform 104 through a blow air injection portion 110 and the preform 104 was stretched in a radial direction. In this manner, a bottle-shaped molded article 112 was obtained.

Next, a barrel section of the obtained bottle-shaped molded article 112 was cut to obtain a base layer of a seamless electrophotographic belt. A thickness of the base layer of the electrophotographic belt was 70.2 μm, a circumferential length thereof was 712.2 mm, and a width thereof was 244.0 mm.

### Preparation of Coating Solution

In the present example, dimples are irregularly arranged on the outer surface of the electrophotographic belt 5.

Surface layer materials used in the examples and the comparative examples will be denoted by the following abbreviations.
AN: Dipentaerythritol penta acrylate and dipentaerythritol hexa acrylate (trade name: ARONIX M-402, manufactured by Toagosei Co., Ltd.)
IRG: Photopolymerization initiator (trade name: Omnirad 907, manufactured by IGM Resins B.V.)
R: Leveling agent (trade name: SYMAC US-270, manufactured by Toagosei Co., Ltd.)
SL: Zinc antimonate particle slurry (trade name: Celnax CX-Z400K, manufactured by Nissan Chemical Corporation, containing 40% by mass of zinc antimonate particles)
CH1: n-hexadecane (manufactured by Fujifilm Wako Pure Chemical Corporation)
CH2: Liquid paraffin (trade name: MORESCO-WHITE P-350P, manufactured by MORESCO Corporation)
CH3: n-tetradecane (manufactured by Fujifilm Wako Pure Chemical Corporation)
D1: Emulsifier (trade name: SY-Glyster PO-5S, manufactured by Sakamoto Yakuhin Kogyo Co., Ltd. (HLB 4.7))
D2: Emulsifier (trade name: SY-Glyster MO-3S, manufactured by Sakamoto Yakuhin Kogyo Co., Ltd. (HLB 8.8))
MIBK: Solvent (trade name: methyl isobutyl ketone, manufactured by KISHIDA CHEMICAL Co., Ltd.)

The surface layer materials were weighed in the ratio of AN/IRG/R/CH1/SL/MIBK=100/8.4/0.3/5.0/50.0/236.3 (mass ratio), and a resin solution was obtained by mixing and stirring the materials excluding SL. By stirring the resin solution while adding SL and further stirring, a coating solution 1 for forming the surface layer was obtained. In the ratio described above, only SL is expressed as a mass ratio based on solid content. The same applies to the other examples and comparative examples below.

### Formation of Surface Layer and Depressed Portions

The base layer obtained by blow molding was fitted onto the outer circumference of a cylindrical mold (circumferential length 712 mm) and ends were sealed. Then, the mold was immersed into a container filled with the coating solution for forming the surface layer, and by raising the mold so that the relative velocity between the liquid surface of the curable composition and the base layer remained constant, a coating film constituted of the coating solution was formed on the surface of the base layer. A withdrawal speed (relative speed between the liquid surface of the curable composition and the base layer) and the solvent ratio of the curable composition can be adjusted according to the required film thickness. In the present example, the withdrawal speed was set to 10 to 50 mm/s and adjusted so that the film thickness of the surface layer reached 3 μm.

In the present example, a coating direction refers to a direction opposite to a withdrawal direction of the base layer. In other words, a point where the base layer is first withdrawn from the coating solution becomes the most upstream point in the coating direction.

The base layer coated by the coating solution was removed from the cylindrical mold and dried for one minute at 23° C. under exhaust conditions. A drying temperature and a drying time were adjusted appropriately based on a solvent type, a solvent ratio, and the film thickness. Subsequently, a UV irradiator (model: UE06/81-3, manufactured by EYE GRAPHICS COMPANY) was used to irradiate the coating film with ultraviolet light until the cumulative light dose reached 600 mJ/cm², thereby curing the coating film.

By wiping off the coating film with a nonwoven fabric impregnated with methyl ethyl ketone (MEK), the intermediate transfer belt 1 with a plurality of dimples was obtained. The dimples of the intermediate transfer belt 1 were irregularly arranged. An evaluation of the sizes of the dimples was performed as described earlier.

In addition, the thickness of the surface layer was determined by a destructive test in which an intermediate transfer belt created separately under the same conditions was cut and its cross-section was observed using an electron microscope (model: XL30-SFEG, manufactured by FEI Company Japan Ltd.). The destructive test revealed that the thickness of the surface layer was 3.0 μm.

Evaluation methods for characteristic values and performance of the intermediate transfer belt 1 fabricated in the present example are as described in [Evaluation 1] to [Evaluation 3] below.

### [Evaluation 1] Evaluation of Shape of Depressed Portions on Intermediate Transfer Belt Surface

An evaluation of the shape of the dimples present on the outer surface of the intermediate transfer belt was performed as described earlier. The electrophotographic belt was observed from the side of the outer surface with a 150× magnification objective lens using a laser microscope (VK-X200, manufactured by KEYENCE CORPORATION). The maximum width WL, the minimum width WS, and the maximum depth DM of each dimple and the area ratio of the dimples observed within a field of view of the outer surface of the observed electrophotographic belt are measured. Since details of the measurement method are as described earlier, a description of details will not be repeated.

### [Evaluation 2] Evaluation of Tack Characteristics and Image Characteristics

Next, a measurement of tackiness between the photosensitive drum 1 and the electrophotographic belt 5 will be described.

Adhesion with a photosensitive drum of a full-color electrophotographic apparatus (model: LBP-5200, manufactured by Canon Inc.) was measured using a jig shown in FIG. 6. The electrophotographic belt 5 was tautened by a driver roller b1 equipped with a motor and a torque meter, a driven roller b4, and a tension roller b3 for tensioning the electrophotographic belt 5. A photosensitive drum and a transfer roller of LBP-5200 were used as a photosensitive drum b2 and a backup roller b5, respectively.

First, the electrophotographic belt 5 in a state where the photosensitive drum is not in contact with the electrophotographic belt 5 is rotated at 180 mm/sec and a torque value at that time is measured. Let this value be “Tq1”.

Next, a maximum value of torque is measured when the photosensitive drum is brought into contact with the electrophotographic belt 5 by 700 gf while rotating the electrophotographic belt 5 at 180 mm/sec. Let this value be “Tq2”. In addition, a difference between “Tq2” and “Tq1” was adopted as an indicator for evaluating the adhesion between the electrophotographic belt 5 and the photosensitive drum 1. Hereinafter, this difference value will be referred to as a tack value.

Exposure blur, which is one of the negative image effects described earlier, occurs due to a sudden change in the friction force between the electrophotographic belt 5 and the photosensitive drum 1 before and after toner is introduced. Therefore, the greater the friction force between the photosensitive drum 1 and the electrophotographic belt 5, the more likely exposure blur is to occur. In other words, exposure blur is more likely to occur when the tack value increases, representing an increase in adhesion.

Based on results of studies carried out by the present inventors, when the tack value is 0.5 [N·m] or higher, an evaluation grade of the exposure blur is “C”, indicating a clear presence of exposure blur. When the tack value is 0.3 [N·m] or higher and lower than 0.5 [N·m], the evaluation grade of the exposure blur is “B”, indicating minor exposure blur. When the tack value is lower than 0.3 [N·m], the evaluation grade of the exposure blur is “A”, indicating that there is hardly any exposure blur.

A final performance of the electrophotographic belt as an intermediate transfer member of an image forming apparatus is determined based on an image grade of exposure blur. On the other hand, a tack value as a performance reference value of a single electrophotographic belt is also measured as an evaluation. The evaluation grade of exposure blur of the electrophotographic belt according to the present example was also “A”.

When bringing the electrophotographic belt and the photosensitive drum into contact with each other in the measurement, the photosensitive drum was not rotated but was fixed and a contact surface of the photosensitive drum was always in a new condition.

### [Evaluation Unit 3] Evaluation of Toner Cleanability

Using the electrophotographic image forming apparatus configured as shown in FIG. 4, an electrophotographic belt was mounted as an intermediate transfer medium, and blade cleaning was performed while printing images to evaluate toner cleanability.

The evaluation was conducted under conditions of 15° C. temperature and 10% relative humidity, using JIS A4-size Extra paper (80 g/m² basis weight) manufactured by Oce Holding B.V. as the recording medium S, paper feeding was performed with 200,000 sheets as an upper limit in a two-sheet intermittent printing mode until toner cleaning was required, and the presence or absence of toner having passed through the cleaning blade was evaluated.

Specifically, first, with the secondary transfer voltage turned off (0 V), the photosensitive drums 1y and 1m were irradiated with laser beams 3y and 3m to record a red image (Y toner and M toner) across the entire A4 size surface. Subsequently, the secondary transfer voltage was set to an appropriate value and three blank sheets were fed continuously.

Since no secondary transfer voltage is applied, the Y toner and the M toner transferred from the photosensitive drums 1y and 1m to the entire surface of the electrophotographic belt 5 enter the cleaning blade 11 with almost none transferred to the recording medium S at the secondary transfer portion. If the entered toner is removed from the electrophotographic belt 5, the subsequent three sheets to be fed will be output as completely blank sheets. On the other hand, if the toner is not removed, the transfer residual toner having passed through the cleaning blade 11 will then be transferred to the recording medium S at the secondary transfer portion. In other words, the toner will be transferred onto blank paper and output onto the recording medium S as a faulty toner cleaning image.

The evaluation described above was performed after feeding 100,000 sheets and after feeding 200,000 sheets. In addition, based on the evaluation results, the electrophotographic belts were ranked according to the following criteria.

When streaks parallel to the transport direction of the recording medium S were visually confirmed to have appeared on a blank region of the recording medium S, it was determined that faulty toner cleaning had occurred.

Rank A: Faulty toner cleaning did not occur after feeding 200,000 sheets.

Rank B: Faulty toner cleaning did not occur after feeding 100,000 sheets but faulty toner cleaning occurred after feeding 200,000 sheets.

Rank C: Faulty toner cleaning occurred after feeding 100,000 sheets.

Using the evaluation method described above, the toner cleaning characteristics of the electrophotographic belt according to present Example 1 were evaluated, whereby faulty toner cleaning did not occur after feeding 200,000 sheets and the electrophotographic belt was determined to be Rank A.

### Example 2

An intermediate transfer belt 2 was created in a similar manner to Example 1 with the exception of changing the compounding ratio of the surface layer materials to AN/IRG/R/CH1/D1/SL/MIBK=100/8.4/0.3/5.0/1.0/50.0/235.3 (mass ratio) and the intermediate transfer belt 2 was evaluated.

### Example 3

An intermediate transfer belt 3 was created in a similar manner to Example 1 with the exception of changing the compounding ratio of the surface layer materials to AN/IRG/R/CH1/D2/SL/MIBK=100/8.4/0.3/5.0/1.0/50.0/235.3 (mass ratio) and the intermediate transfer belt 3 was evaluated.

### Example 4

An intermediate transfer belt 4 was created in a similar manner to Example 1 with the exception of changing the compounding ratio of the surface layer materials to AN/IRG/R/CH1/D2/SL/MIBK=100/8.4/0.3/5.0/2.0/50.0/234.3 (mass ratio) and the intermediate transfer belt 4 was evaluated.

### Example 5

An intermediate transfer belt 5 was created in a similar manner to Example 1 with the exception of changing the compounding ratio of the surface layer materials to AN/IRG/R/CH1/SL/MIBK=100/8.4/0.3/10.0/50.0/231.3 (mass ratio) and the intermediate transfer belt 5 was evaluated.

### Example 6

An intermediate transfer belt 6 was created in a similar manner to Example 1 with the exception of changing the compounding ratio of the surface layer materials to

AN/IRG/R/CH1/SL/MIBK=100/8.4/0.3/7.5/50.0/233.8 (mass ratio) and the intermediate transfer belt 6 was evaluated.

### Example 7

An intermediate transfer belt 7 was created in a similar manner to Example 1 with the exception of changing the compounding ratio of the surface layer materials to AN/IRG/R/CH2/D2/SL/MIBK=100/8.4/0.3/15.0/1.0/50.0/225.3 (mass ratio) and the intermediate transfer belt 7 was evaluated.

### Example 8

An intermediate transfer belt 8 was created in a similar manner to Example 1 with the exception of changing the compounding ratio of the surface layer materials to AN/IRG/R/CH3/D2/SL/MIBK=100/8.4/0.3/5.0/1.0/50.0/235.3 (mass ratio) and the intermediate transfer belt 8 was evaluated.

### Comparative Example 1

An intermediate transfer belt 9 was created in a similar manner to Example 1 with the exception of changing the compounding ratio of the surface layer materials to AN/IRG/R/SL/MIBK=100/8.4/0.3/50.0/241.3 (mass ratio) and the intermediate transfer belt 9 was evaluated.

### Comparative Example 2

An intermediate transfer belt 10 was created in a similar manner to Example 1 with the exception of changing the compounding ratio of the surface layer materials to AN/IRG/R/CH1/SL/MIBK=100/8.4/0.3/20.0/50.0/221.3 (mass ratio) and the intermediate transfer belt 10 was evaluated.

### Comparative Example 3

An intermediate transfer belt 11 was created in a similar manner to Example 1 with the exception of changing the compounding ratio of the surface layer materials to AN/IRG/R/CH1/D1/SL/MIBK=100/8.4/0.3/5.0/5.0/50.0/231.3 (mass ratio) and the intermediate transfer belt 11 was evaluated.

### Comparative Example 4

An intermediate transfer belt 12 was created in a similar manner to Example 1 with the exception of changing the compounding ratio of the surface layer materials to AN/IRG/R/CH2/SL/MIBK=100/8.4/0.3/20.0/50.0/221.3 (mass ratio) and the intermediate transfer belt 12 was evaluated.

### Comparative Example 5

The surface layer materials were weighed in the ratio of AN/IRG/R/PTFE/SL/MIBK=100/8.4/0.3/20.0/50.0/221.3 (mass ratio), and a solution was prepared by performing coarse dispersion processing on the materials excluding SL. In addition, dispersion of the obtained solution was performed using a high-pressure emulsifying disperser (model: Nanovator, manufactured by YOSHIDA KIKAI CO., LTD.). This dispersion processing was carried out until a 50% average particle size of the PTFE contained in the solution reached 200 nm. In this case, PTFE refers to fluorine resin (polytetrafluoroethylene) particles.

While further stirring the SL, the solution from the completed dispersion processing was dripped to yield a coating solution 13 for forming the surface layer. Subsequently, a coating film constituted of the coating solution 13 was formed on the surface of the base layer and the coating film was cured in a similar manner to Example 1.

Fluorine resin particles exposed on the outer surfaces of the obtained intermediate transfer belts were removed by rubbing the outer surfaces with a woven fabric (trade name: BEMCOT AZ-8, manufactured by Ozu Corporation). Accordingly, the fluorine resin particles were removed and an intermediate transfer belt 13 with its outer surface dotted with dimples was obtained. The intermediate transfer belt 13 was also evaluated in a similar manner to Example 1.

Table 1 summarizes parts of the compounding ratios for the coating solutions 1 to 13 according to the examples and comparative examples described above.

TABLE 1

| | | Hydrocarbon oil etc. | | Dispersant | | Solvent | |
|---|---|---|---|---|---|---|---|
| | | | Material | | Material | | Material |
| | | Type | ratio | Type | ratio | Type | ratio |
| Example 1 | Coating solution 1 | CH1 | 5.0 | None | — | MIBK | 236.3 |
| Example 2 | Coating solution 2 | CH1 | 5.0 | D1 | 1.0 | MIBK | 235.3 |
| Example 3 | Coating solution 3 | CH1 | 5.0 | D2 | 1.0 | MIBK | 235.3 |
| Example 4 | Coating solution 4 | CH1 | 5.0 | D2 | 2.0 | MIBK | 234.3 |
| Example 5 | Coating solution 5 | CH1 | 10.0 | None | — | MIBK | 231.3 |
| Example 6 | Coating solution 6 | CH1 | 7.5 | None | — | MIBK | 233.8 |
| Example 7 | Coating solution 7 | CH2 | 15.0 | D2 | 1.0 | MIBK | 225.3 |
| Example 8 | Coating solution 8 | CH3 | 5.0 | D2 | 1.0 | MIBK | 235.3 |
| Comparative | Coating solution 9 | None | — | None | — | MIBK | 241.3 |
| Example 1 | | | | | | | |
| Comparative | Coating solution 10 | CH1 | 20.0 | None | — | MIBK | 221.3 |
| Example 2 | | | | | | | |
| Comparative | Coating solution 11 | CH1 | 5.0 | D1 | 5.0 | MIBK | 231.3 |
| Example 3 | | | | | | | |
| Comparative | Coating solution 12 | CH2 | 20.0 | None | — | MIBK | 221.3 |
| Example 4 | | | | | | | |
| Comparative | Coating solution 13 | PTFE | 20.0 | None | — | MIBK | 221.3 |
| Example 5 | | | | | | | |

Table 2 summarizes the results of the evaluations of intermediate transfer belts 1 to 13.

TABLE 2

| | | | Intermediate transfer belt properties | | | | | | | |
|---|---|---|---|---|---|---|---|---|---|---|
| | | | | | Depressed | | | | | |
| | | | | | portion | | | Performance evaluation | | |
| | | | Depressed | Depressed | depth/long | Aspect | | | Image | |
| | | Coating | portion | portion | axis | ratio | | | evaluation | |
| | | solution | long axis | depth | DMAve/ | (WS/ | Area | Tack | Exposure | Toner |
| | | used | WLAve | DMAve | WLAve | WL)Ave | ratio | value | blur grade | cleanability |
| Example 1 | Intermediate | Coating | 2.8 | 0.60 | 0.21 | 0.9 | 26.3 | 0.2 | A | A |
| | transfer belt | solution | | | | | | | | |
| | 1 | 1 | | | | | | | | |
| Example 2 | Intermediate | Coating | 2.3 | 0.52 | 0.23 | 0.9 | 33.6 | 0.2 | A | A |
| | transfer belt | solution | | | | | | | | |
| | 2 | 2 | | | | | | | | |
| Example 3 | Intermediate | Coating | 1.8 | 0.42 | 0.23 | 0.9 | 38.2 | 0.2 | A | A |
| | transfer belt | solution | | | | | | | | |
| | 3 | 3 | | | | | | | | |
| Example 4 | Intermediate | Coating | 1.3 | 0.25 | 0.19 | 0.9 | 48.2 | 0.2 | A | B |
| | transfer belt | solution | | | | | | | | |
| | 4 | 4 | | | | | | | | |
| Example 5 | Intermediate | Coating | 3.9 | 1.13 | 0.29 | 1.0 | 30.1 | 0.2 | A | B |
| | transfer belt | solution | | | | | | | | |
| | 5 | 5 | | | | | | | | |
| Example 6 | Intermediate | Coating | 3.2 | 0.84 | 0.26 | 1.0 | 29.8 | 0.2 | A | B |
| | transfer belt | solution | | | | | | | | |
| | 6 | 6 | | | | | | | | |
| Example 7 | Intermediate | Coating | 3.4 | 0.79 | 0.23 | 1.0 | 24.3 | 0.3 | B | B |
| | transfer belt | solution | | | | | | | | |
| | 7 | 7 | | | | | | | | |
| Example 8 | Intermediate | Coating | 0.5 | 0.12 | 0.24 | 0.9 | 44.3 | 0.2 | A | A |
| | transfer belt | solution | | | | | | | | |
| | 8 | 8 | | | | | | | | |
| C.E. 1 | Intermediate | Coating | — | — | — | — | — | 0.6 | C | A |
| | transfer belt | solution | | | | | | | | |
| | 9 | 9 | | | | | | | | |
| C.E. 2 | Intermediate | Coating | 5.1 | 2.03 | 0.40 | 1.0 | 37.4 | 0.2 | A | C |
| | transfer belt | solution | | | | | | | | |
| | 10 | 10 | | | | | | | | |
| C.E. 3 | Intermediate | Coating | 0.2 | 0.03 | 0.15 | 0.8 | 60.3 | 0.6 | C | A |
| | transfer belt | solution | | | | | | | | |
| | 11 | 11 | | | | | | | | |
| C.E. 4 | Intermediate | Coating | 4.4 | 1.84 | 0.42 | 0.9 | 45.0 | 0.2 | A | C |
| | transfer belt | solution | | | | | | | | |
| | 12 | 12 | | | | | | | | |
| C.E. 5 | Intermediate | Coating | 1.4 | 0.91 | 0.65 | 0.9 | 52.3 | 0.2 | A | C |
| | transfer belt | solution | | | | | | | | |
| | 13 | 13 | | | | | | | | |

In the table 2, C.E. represents Comparative Example.

The intermediate transfer belts with a C grade in the performance evaluation were deemed unacceptable and unusable.

Depressed portions were not present on the outer surface of the electrophotographic member obtained in Comparative example 1 which exhibited a high tack value and a C grade with respect to exposure blur in image evaluation.

Comparative example 5 represents an example of forming dimples by the absence of particles and is an example that does not satisfy expression (3). A C grade was given for cleanability due to toner entering the dimples.

An aspect of the present disclosure provides an electrophotographic member to be used in an electrophotographic image forming apparatus equipped with a cleaning blade, the electrophotographic member having low adhesion to a photosensitive drum, reduced occurrence of exposure blur, and excellent toner cleanability over a long period of time. Another aspect of the present disclosure provides an electrophotographic image forming apparatus equipped with the electrophotographic member according to the present disclosure as an intermediate transfer belt.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-229191, filed Dec. 25, 2024, which is hereby incorporated by reference herein in its entirety.

What is claimed is:

1. An electrophotographic member having, on an outer surface thereof, a plurality of dimples, wherein
regarding each shape of the plurality of dimples, in each of the dimples, when a maximum width of the dimple is denoted as WL (μm), a minimum width of the dimple is denoted as WS (μm), a maximum depth of the dimple is denoted as DM (μm), and in the plurality of dimples, when an arithmetic mean value of WS/WL is denoted as (WS/WL) Ave, an arithmetic mean value of WL is denoted as WLAve (μm), and an arithmetic mean value of DM is denoted as DMAve (μm), then (WS/WL) Ave, WLAve, and DMAve satisfy expressions (1) to (4) below:
$$( WS / WL ) Ave \geq 0.6 \qquad ( 1 )$$
$$0.5 μm \leq WLAve \leq 4. μm \qquad ( 2 )$$
$$0. < ( DMAve / WLAve ) \leq 0.3 \qquad ( 3 )$$
$$DMAve \geq 0.1 μm , \qquad ( 4 )$$
and
a percentage of an area occupied by the dimples on the outer surface is 20.0 to 50.0 area %.

2. The electrophotographic member according to claim 1, wherein the percentage of the area occupied by the dimples on the outer surface is 26.0 to 45.0 area %.

3. The electrophotographic member according to claim 1, wherein
WLAve and DMAve satisfy an expression (3-4) below:
$$0.10 \leq ( D M Ave / WLAve ) \leq 0.3 . \qquad ( 3 - 4 )$$

4. The electrophotographic member according to claim 1, wherein
WLAve satisfies an expression (2-1) below:
$$1.5 μm \leq WLAve \leq 3.5 μm . \qquad ( 2 - 1 )$$

5. An electrophotographic image forming apparatus comprising an intermediate transfer belt, wherein
the intermediate transfer belt is an electrophotographic member having, on an outer surface thereof, a plurality of dimples,
regarding each shape of the plurality of dimples, in each of the dimples, when a maximum width of the dimple is denoted as WL (μm), a minimum width of the dimple is denoted as WS (μm), a maximum depth of the dimple is denoted as DM (μm), and in the plurality of dimples, when an arithmetic mean value of WS/WL is denoted as (WS/WL) Ave, an arithmetic mean value of WL is denoted as WLAve (μm), and an arithmetic mean value of DM is denoted as DMAve (μm), then (WS/WL) Ave, WLAve, and DMAve satisfy expressions (1) to (4) below:
$$( WS / WL ) Ave \geq 0.6 \qquad ( 1 )$$
$$0.5 μm \leq WLAve \leq 4. μm \qquad ( 2 )$$
$$0. < ( DMAve / WLAve ) \leq 0.3 \qquad ( 3 )$$
$$DMAve \geq 0.1 μm , \qquad ( 4 )$$
and
a percentage of an area occupied by the dimples on the outer surface is 20.0 to 50.0 area %.

6. The electrophotographic image forming apparatus according to claim 5, comprising a blade member as a cleaning member of the electrophotographic member.
